(19) United States
(12) Patent Application Publication
(10) Pub. No.: US 2008/0143117 A1
(43) Pub. Date: Jun. 19, 2008

(54) High efficiency wind turbine system

(76) Inventors: Weiqing Shen, Shanghai (CN); Jian Shen, Shanghai (CN)

Correspondence Address: ANNA WU, P.O. BOX 93286, CITY OF INDUSTRY, CA, 91715, US

(21) Appl. No.: 11/804,989

(22) Filed: May 21, 2007

(30) Foreign Application Priority Data
Dec. 18, 2006 (CN) 200610147422.7
May 18, 2007 (CN) 200710040799.7

(51) Int. Cl. F03D 9/00; F03D 11/00; F03D 9/02

(52) U.S. Cl. 290/55

(57) ABSTRACT

A wind turbine system is disclosed, such wind turbine includes a wind turbine generator, a plurality of turbine blades radially extended from the generator and a wind-catching unit is provided for circularly sheltering the generator, wherein the wind-catching unit comprises a plurality of wind suction channels completely covering four sides and arranged in a side by side manner. Each of the wind suction channels has a wind inlet for sucking wind from outside, a wind outlet towards the generator blades, and a gradually reduced cavity communicating the wind inlet and wind outlet so as to generate a turbulent pressure between the wind inlet and wind outlet in such a manner that when wind from a direction is caught by the respective wind suction channel, the caught wind will be compressed through the gradually reduced cavity so as to effectively blow out from the wind outlet to rotate the generator.

### BACKGROUND OF THE PRESENT INVENTION

1. Field of Invention

The present invention relates to a wind turbine generating system, and more particularly, relates to a kind of high efficiency wind turbine generating system that is capable of maximally utilizing wind power from all directions and converting wind energy trapped by the wind turbine into electricity in an environmental manner.

2. Description of Related Arts

Electricity is traditionally generated through the burning of fossil fuel. The burning of such fuel releases greenhouse gases into the atmosphere that contributes to the global climate change and affects our environment. While generating electricity by wind energy (a kind of renewable energy) can avoid the above problem and offer a proven alternative to the burning of fossil fuel. In addition, as compared with nuclear, hydraulic, thermal power generating system, the wind turbine generating system is very economical in terms of the construction cost and occupied space.

Wind energy is rich and never to an end in the world. In theory, converting 1% of the wind energy into electricity can meet the energy requirements of all people in the world. However, there is no omni-directional wind turbine disclosed within the art for maximally catching wind power from all directions. In other words, a conventional wind turbine generator is in extreme low efficiency.

Commonly, a wind turbine is provided onto a windmill, which is applied as a synchronous generator and power is generated as the windmill is rotated by wind energy. Unfortunately, when the wind blows against such conventional windmill, the blades of the windmill would have caught only less than 30% of the wind energy□while the remaining 70% of the wind energy would escape from the gaps between blades of the windmill. What makes things worse is that the wind trapped by the blades would not always exert forces on the blades in single direction. Most of the time, the caught wind energy would generate turbulent impact on the blades. In case of two opposite forces push against with each other, the wind energy would be offset on the blades. Therefore, only a small portion of the caught wind energy would be used for electricity generation. Therefore, low efficiency is one of fatal drawbacks of a conventional wind turbine system.

In order to overcome the above problem, considerable efforts have been devoted for improving the conventional wind turbine unit. It is witnessed that main shaft of the windmill had been raised, the blades of the windmill have been enlarged to catch more wind, and the power of the generator have been increased. However, such methods only resulted to expensive and bulky windmills.

Theoretically, when wind speed reaches 14 m/s, the wind turbine would be substantially energized to generate electricity. However, higher wind speed would also increase the risk of the windmill. To prevent the windmill from being collapsed by strong wind, most of the windmill blades had been wrapped around, or the wind turbines had been equipped with side windings. Or even conservatively, the size of the blades had been significantly reduced. What is worse, to protect wild birds or the like, some countries or regions merely prohibit using conventional windmills in certain season.

Therefore, a new wind turbine system, which is high efficient, energy saving, capable of maximally utilizing wind energy, and saving wild birds would be definitely welcome within the art.

### SUMMARY OF THE PRESENT INVENTION

A primary object of the invention is to provide a wind turbine system, which is capable of maximally trapping wind power, and efficiently converting trapped wind energy into electricity in an environmental manner.

Another object of the invention is to provide a wind turbine system, which is safe in structure for not only withstanding strong wind, but also for generating electricity with high efficiency.

Another object of the present invention is to provide a wind turbine system, which comprises an omni-directional wind-catching unit for optimally trapping wind power from all directions, and meanwhile guiding trapped wind directly onto the wind turbine so as to smooth out the airflow on the turbine. In other words, no matter the wind blow from which direction, the wind-catching unit of the present invention would effectively catch the wind and convert the wind into electricity.

Another object of the present invention is to provide a wind turbine system, which inherently possesses all features of conventional wind turbines but eliminates unnecessary supplemental equipments of conventional wind turbines, such as side windings and overall wrappings.

Another object of the present invention is to provide a wind turbine system, which is covered by a protective net for protecting wild birds so as to maintain Ecosystem Balance, whereas such protective net would not affect the normal function of the wind turbine.

Another object of the present invention is to provide a wind turbine system, wherein such wind turbine system is arranged in series to generate electricity without occupying extra spaces and complicated installation procedures.

Another object of the present invention is to provide a wind turbine system, wherein no complicated equipments, parts or expensive labor would be required to achieve the above mentioned objects.

Accordingly, in order to accomplish the above objects, the present invention provides a wind turbine generating system, which comprises:

an upright shaft;

a wind turbine generator having a generator body mounted onto the upright shaft, and a plurality of turbine blades radially expanded from the generator body, wherein the plurality of turbine blades are driven to rotate with respect to the generator body to generate electricity; and

a wind-catching unit mounted onto the upright shaft for sheltering the wind turbine, wherein the wind-catching unit comprises a plurality of wind suction channels completely covering four sides and arranged in a side by side manner, wherein each of the wind suction channels has a wind inlet for sucking wind from outside, a wind outlet towards the turbine blades of the wind turbine, and a gradually reduced cavity communicating the wind inlet and wind outlet so as to generate a turbulent pressure between the wind inlet and wind outlet in such a manner that when wind from a direction is caught by respective wind suction channel, the caught wind will be compressed through the gradually reduced cavity so as to effectively blow out from the wind outlet to rotate the generator body with respect to the shaft to generate electricity.

Each of the wind suction channels is horn shaped with an eccentric angle so as to enable each of the wind outlets is longitudinally provided adjacent to the wind generator blades, and the wind inlet is outwardly and radially extended from the wind outlet with an eccentric angle.

The wind turbine generating system comprises a bird-preventing helmet for protecting birds from being sucked into the wind inlet of the wind-catching unit, and a storage battery electrically connected with the wind turbine generator for storing electricity.

In addition, a plurality of the wind turbine systems can be combined in a vertical group manner or in a horizontal group manner to generate electricity without occupying extra spaces and complicated installation procedures.

### BRIEF DESCRIPTION OF THE DRAWINGS

FIG. 1 is a schematic view of a wind turbine generating system according to a preferred embodiment of the present invention.

FIG. 2 is a schematic view of a wind turbine generator according to the above preferred embodiment of the present invention.

FIG. 3 is a 3-3 sectional view of the wind turbine generator of FIG. 2 according to the above preferred embodiment of the present invention.

FIG. 4 is a front view of the wind turbine generating system of the above preferred embodiment of the present invention, illustrating the wind turbine generator is surrounded by the wind-catching unit.

FIG. 5 is a top view of FIG. 4 according to the above preferred embodiment of the present invention showing that no matter which direction the wind is caught, the wind-catching unit is capable of effectively utilizing the wind energy to rotate the wind turbine generator.

FIG. 6 is a schematic view of a vertical combination of the wind turbine generating system provided on the land or building roof according to the above preferred embodiment of the present invention.

FIG. 7 is a schematic view of a horizontal combination of the wind turbine generating system provided between the buildings according to the above preferred embodiment of the present invention.

### DETAILED DESCRIPTION OF THE PREFERRED EMBODIMENT

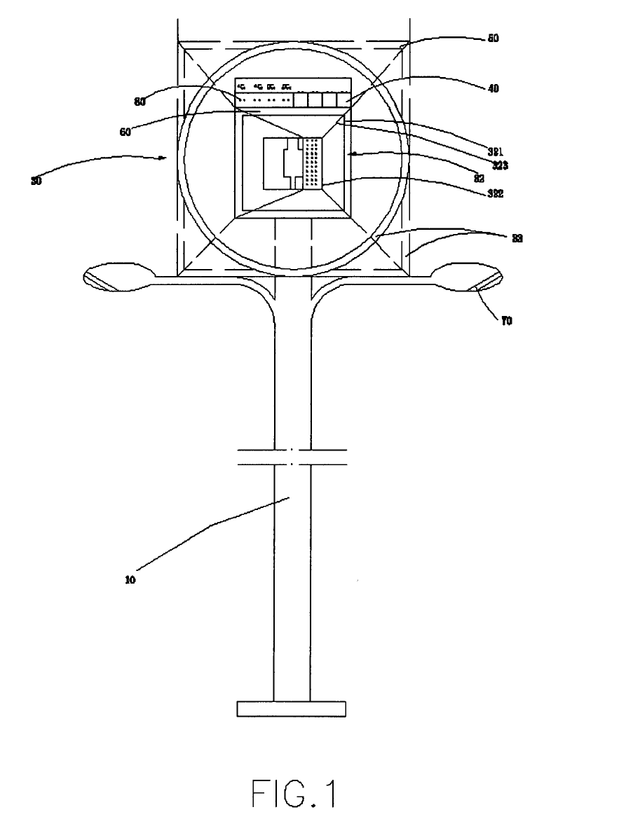

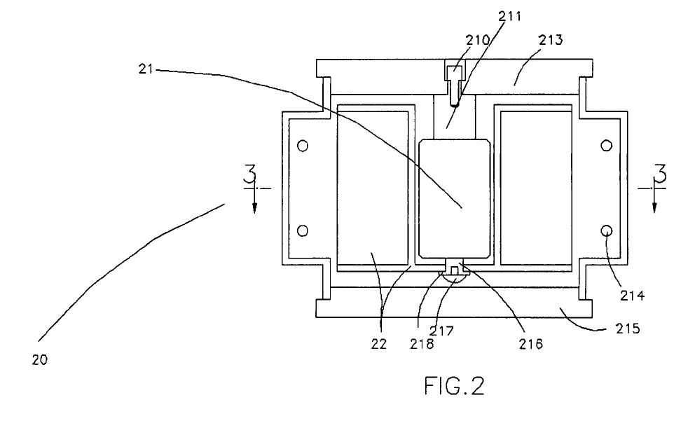

Referring to FIG. 1 and FIG. 2, the wind turbine generating system according to a preferred embodiment of the present invention is illustrated. The wind turbine generating system comprises an upright shaft 10, a wind turbine generator 20 having a generator body 21 firmly mounted onto the upright shaft 10, and a plurality of turbine blades 22 radially extended from the generator body 21, wherein the plurality of turbine blades 22 are driven to rotate with respect to said generator body to generate electricity.

Like conventional wind turbines, whenever the airflow is impacting onto the turbine blades 22, the turbine blades 22 would be driven into rotation with respect to the upright shaft 10 for electricity generation.

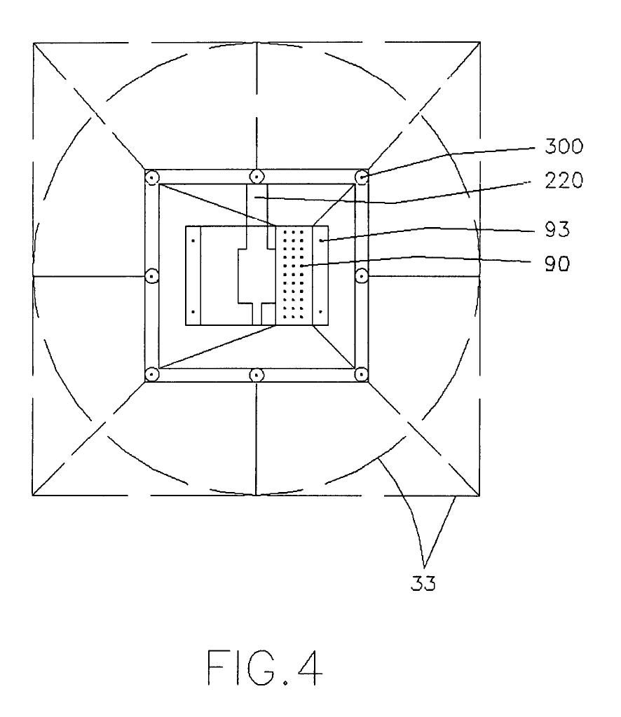

Referring to FIG. 1 and FIG. 4, the wind turbine generating system of the present invention further comprises a wind-catching unit 30 for circularly sheltering the wind turbine generator 20, wherein the wind-catching unit 30 comprises four wind suction channels 32 at four respective sides and arranged in a side by side manner. Each of the wind suction channels 32 has a wind inlet 321 for sucking wind from outside, a wind outlet 322 towards the turbine blades 22 of the wind turbine, and a gradually reduced cavity 323 communicating with the wind inlet 321 and wind outlet 322 so as to generate a turbulent pressure between the wind inlet 321 and wind outlet 322.

According to the preferred embodiment of the present invention, the wind-catching unit 30 is provided for maximally catching wind from all directions. The wind-catching unit 30 comprises four wind suction channels 32 respectively oriented towards four directions, i.e. east, south, west, and north direction, wherein each of the wind suction channels is horn shaped with an eccentric angle so as to enable each of the wind outlets 322 to be longitudinally provided adjacent to the wind generator blades 22, and the wind inlet 321 is outwardly and radially extended from the wind outlet 322 with an eccentric angle. As a result, when wind is blow out through the gradually reduced wind suction channel 32, a compressed wind pressure will impact onto the circumferential blade edges area of the generator body 21 instead of the central portion of the generator body 21. The wind turbine generator 20 will be effectively driven to rotate.

Therefore, no matter the wind blows from east, west, north, south, or any other directions within 360°, such as from east or south direction, at least one wind suction channel would catch the wind to certain extent. After the caught wind flowing along the eccentric-angled and gradually reduced suction channel 32, the wind blow out from the wind outlet 322 would be compressed into strengthened wind, which is twice the power. The wind-catching unit 30 of the present invention not only increases the wind speed V, but also increases the wind blow area A and the air density ρ. According to the follow function:

W=½ρV³A

It is clearly understood that if one of the wind blow area, air density, and wind speed is increased, the wind energy will be increased as well. That is, as long as the wind speed is twice times it was, the power of the wind turbine unit will be increased to a four-fold extent.

As shown in FIG. 1, the wind turbine generating system further comprises a storage battery 40 electrically connected with the wind turbine generator 20 in such manner when wind from a direction is caught by respective wind suction channel 32, the caught wind will be compressed through the gradually reduced cavity 323 so as to effectively blow out from the wind outlet 322 to rotate the generator body 21 with respect to the shaft 10 to generate electricity and charge the storage battery 40.

Referring to FIGS. 1 and 4 of the drawings, the wind-catching unit 30 further comprises a catcher head 33 mounted around the wind suction channel 32. Depending on the catcher head 33, the wind-catching area of the wind-catching unit 30 is further increased in such manner the output power of the wind turbine generator 20 will be increased without increasing the rated power of the turbine generator 20. In addition, the size of the catcher head 33 is fitly matched with the requested output power of the wind turbine generator 20, and can be constructed into several kinds of shapes, such as circular cross section, rectangular cross section.

Referring to FIG. 1 of the drawings, the wind turbine generating system according to the preferred embodiment of the present invention further comprises an optical control solar panel 50 for collecting solar energy and illumination, and a generator holder 60 for securing the wind turbine generating system in position, wherein the generator holder 60 is made of steel, aluminum alloy, or stainless steel. Preferably, the wind suction channels 32 are made of fiber glass, stainless steel, or engineering plastic.

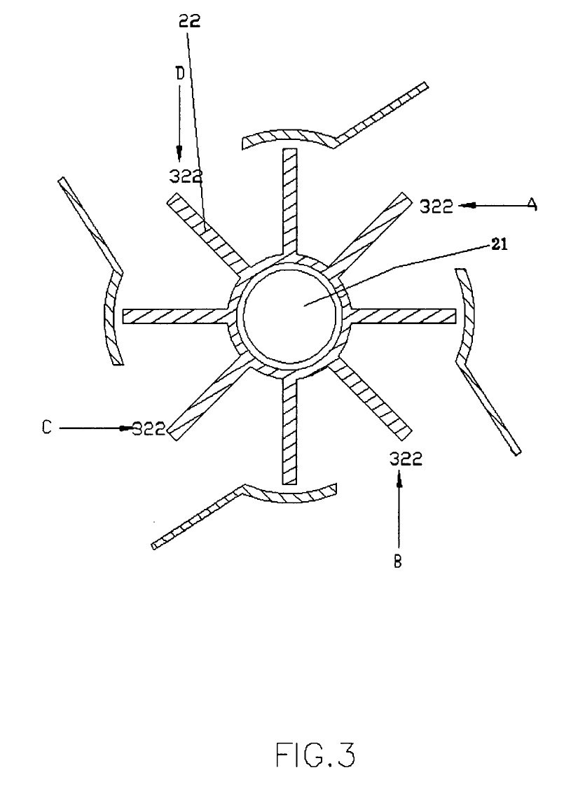

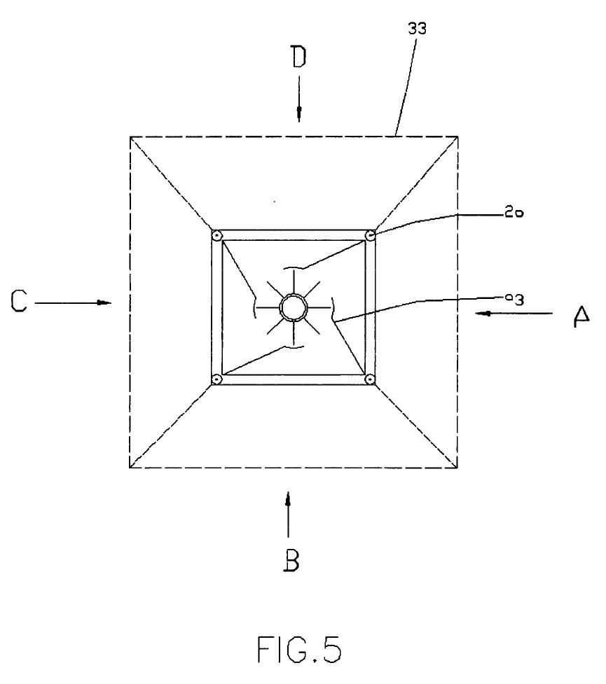

As shown in FIGS. 1, 3 and 5, the wind-catching unit 30 is evenly divided into four portions for respectively catching wind from east, west, south and north direction. In other words, the wind-catching unit 30 is made up of four horn shaped channels 32, wherein each of such horn shaped channels 32 has a big opening 321 towards outside for catching wind while the small openings 322 toward inwardly for blowing air onto the blades 22 of the wind turbine. Accordingly, such horn shaped channels 32 could be prolonged to increase the power.

As shown in FIGS. 1, 2, and 3, the wind turbine generating system of the present invention unit further comprises a set of energy-saved lights 70, a controller 80, and a bird-preventing helmet 90 made of stainless steel wires or web fastened by a plurality of rivets 93.

It is noted that the catcher head 33 is made of enhanced nylon, fiber glass fastened around the wind suction channel 32 by a plurality of screws 300. Meanwhile, the wind turbine generator 20 is manufactured in compliance with the rated power, and has a generator tail 211.

In addition, an upper tie panel 213 and a bottom tie panel 215 made of steel or aluminum alloy are used to hold the wind turbine generator 20, and a plurality of rivet holes 214 formed on the wind-driven generator 20 for accommodating the rivets. The wind-driven generator 20 is fastened to the generator holder 60 by a plurality of set screws 210 made of steel or aluminum alloy inserted into the generator tail 211. The turbine blades 22 of the wind turbine generator 20 are made of plastic, stainless steels, or lighting carbon fiber. Moreover, there are connection components 220 provided to further fasten the generator 20 to the center of the generator holder 60 and the wind turbine unit further comprises a plurality of assembled bolts 26 made of high intensity steel or stainless steel adapted for joining with another wind turbine unit.

Because of the eccentric guiding structure of the wind suction channel 32, the caught wind can exerts forces on a given part of the turbine blades 22, i.e. the outer edge of the turbine blades 22. In other words, the outer edge of such turbine blades 22 would be under high pressure of wind power. On the other hand, the rest part of the turbine blades 22 can avoid suffering a force exerted by the caught wind. Therefore, no opposite forces would be exerted onto the turbine blades 22 at the same time. The turbine blades 22 would only rotate in either counterclockwise or clockwise manner. For example, the wind blows from the direction of A, after passing through the wind inlet 321, the wind blows into the wind-driven generator 20 through the wind suction channel 32, at the very moment the turbine blades 22 will be driven to rotate to produce electrical energy. If the wind comes from a diagonal direction between D and C, after driving the turbine blades 22, the wind is released outside from the wind suction channel 32 in A and B directions, at that time, the air density and wind speed at the wind outlet 322 are greatly increased.

For example, the natural wind has a speed of 3.5 m/s, the wind speed at the wind-suction channels 32 also will be 3.5 m/s, and the air density is only 50 W/m². But if a wind-catching unit 30 is provided with the wind turbine unit, the natural wind after being caught by the wind inlet 321, flows along the reduced cavity 323 to the wind outlet 322, and finally reaches the turbine blades 22. Depending on these eccentric structures, the wind speed at wind-suction channels 32 becomes about two times what it was, while the air density is increased to 400 W/m². Therefore, the output power of the wind turbine unit becomes about 9 times what it was.

As shown in FIGS. 1 and 4, the netted lines stand for the bird-preventing helmet 90 is illustrated, wherein such bird-preventing helmet 90 is made of stainless steel wires and webs, and the grids of the bird-preventing helmet 90 are smaller than little birds. The bird-preventing helmet 90 is fastened to the wind turbine generator 20 by rotating the rivets 93 into the rivet holes 214 for covering the wind outlet 322, such that birds cannot fly into the wind outlet 322.

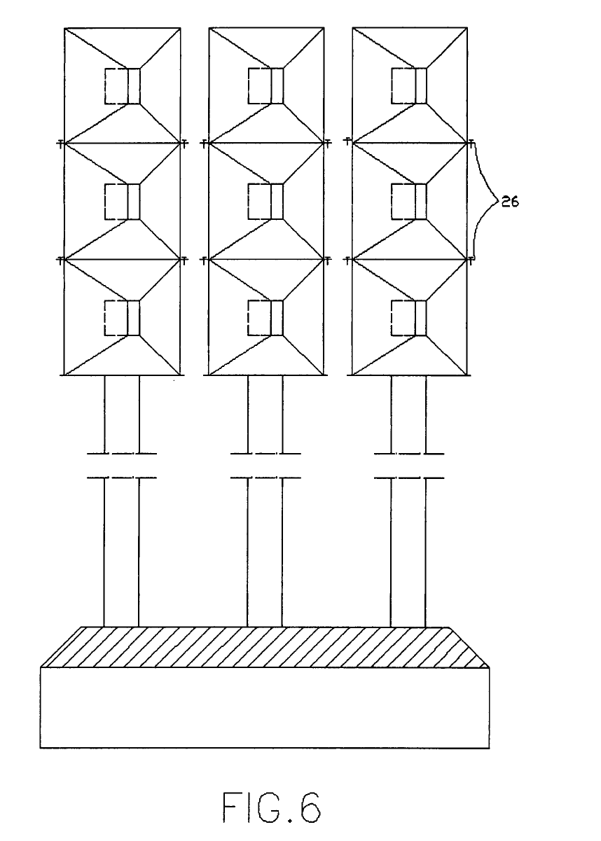

Referring to FIGS. 6 and 7 of the drawings, it is illustrated that a plurality of wind turbine systems of the present invention could be systematically combined to establish a wind turbine generating assembled line, wherein individual wind turbine could be arranged in horizontal or vertical manner. As shown in FIG. 6, a plurality of wind turbine units is combined in vertical by the assembled bolts 26 placed on the land or the building roof. As shown in FIG. 7, a plurality of turbine units is combined in horizontal by the assembled bolts 26 placed between the buildings or above the bridges spanning across the water.

As shown in the FIG. 1, a supplementary generation system with wind and sunlight is displayed, wherein an optical control solar panel 50, a set of storage battery 40, and a controller 80 are disposed on the top surface of the generator holder 60, while a set of energy-saved lights 70 is installed at the bottom of the generator holder 60 for optical control. When the days have little sunshine, the energy-saved lights 70 will automatically start up for supplying light, while at the days with beautiful sunshine, the energy-saved lights 70 will automatically deactivate to save current, and the optical control solar panel 50 begins to absorb sunlight and a DC current is produced, wherein the DC current is stored within the set of storage battery 40. But if the cloudy or rainy days last for a long time, a demand of current for the energy-saved lights 70 will be beyond the stored DC current, which makes the energy-saved lights 70 stop work. However, a special supplementary generation system utilizing natural wind and sunlight is formed by combining the optical-control solar panel 50 with the safe wind turbine unit. The special supplementary generation system with wind and sunlight can generate electricity day and night; especially under a time with heavy rain and strong wind, the system can generate electricity more easily. The above advantages are obtained depending on the follow structure. Firstly, the four wind outlets 322 of the wind suction channels 32 are smoothly communicated with the turbine blades 22 of the turbine generator 20. Secondly, the turbine blades 22 tightly fastened to a main shaft 216 by a compressing screw 217 and a compressing panel 218. Therefore, when turbine blades 22 is driven by a strong wind, it will rotate with a high speed to incise the magnetic force line referring the main shaft 216 as a centre, such that a strong current will be produced and pass through the controller 80 to be stored within the set of storage battery 40.

After the preferred embodiments are listed, one skilled in art should understand that any change or improvement without departure from the spirit and principle is still in the scope of the present invention.

What is claimed is:

1. A wind turbine generating system, comprising:
an upright shaft;
a wind turbine generator having a generator body mounted onto said upright shaft, and a plurality of turbine blades radially expanded from said generator body, wherein said plurality of turbine blades are driven to rotate with respect to said generator body to generate electricity; and
a wind-catching unit mounted onto said upright shaft for sheltering said wind turbine, wherein said wind-catching unit comprises a plurality of wind suction channels completely covering four sides and arranged in a side by side manner, wherein each of said wind suction channels has a wind inlet for sucking wind from outside, a wind outlet towards said turbine blades of said wind turbine, and a gradually reduced cavity communicating said wind inlet and wind outlet so as to generate a turbulent pressure between said wind inlet and wind outlet in such a manner that when wind from a direction is caught by respective wind suction channel, said caught wind will be compressed through said gradually reduced cavity so as to effectively blow out from said wind outlet to rotate said generator body with respect to said shaft to generate electricity.

2. The wind turbine system, as recited in claim 1, further comprising a storage battery electrically connected with said turbine generator for storing electricity.

3. The wind turbine system, as recited in claim 1, wherein each of said wind suction channels is horn shaped with an eccentric angle so as to enable each of said wind outlets to be longitudinally provided adjacent to said wind generator blades, and said wind inlet is outwardly and radially extended from said wind outlet with an eccentric angle.

4. The wind turbine system, as recited in claim 2, wherein each of said wind suction channels is horn shaped with an eccentric angle so as to enable each of said wind outlets is longitudinally provided adjacent to said wind generator blades, and said wind inlet is outwardly and radially extended from said wind outlet with an eccentric angle.

5. The wind turbine system, as recited in claim 3, wherein each of said wind outlets is positioned orientated towards a circumferential edge of said turbine blade wherein when wind is blow out through said gradually reduced wind suction channel, a compressed wind pressure will impact onto said circumferential edges of said generator blade instead of a central portion of said generator body for ensuring said wind turbine generator effectively driven to rotate.

6. The wind turbine system, as recited in claim 4, wherein each of said wind outlets is positioned orientated towards a circumferential edge of said turbine blade wherein when wind is blow out through said gradually reduced wind suction channel, a compressed wind pressure will impact onto said circumferential edges of said generator blade instead of a central portion of said generator body for ensuring said wind turbine generator effectively driven to rotate.

7. The wind turbine system as recited in claim 1, further comprising an optical control solar panel for collecting solar energy and illumination.

8. The wind turbine system as recited in claim 4, further comprising an optical control solar panel for collecting solar energy and illumination.

9. The wind turbine system as recited in claim 5, further comprising an optical control solar panel for collecting solar energy and illumination.

10. The wind turbine system, as recited in claim 1, further comprising a bird-preventing helmet for protecting birds from being sucked into said wind outlet of said wind-catching unit.

11. The wind turbine system, as recited in claim 5, further comprising a bird-preventing helmet for protecting birds from being sucked into said wind outlet of said wind-catching unit.

12. The wind turbine system, as recited in claim 1, wherein said wind-catching unit further comprises a catcher head mounted around said catcher body for increasing the area of said wind-catching unit in such manner the output power of said wind generator will be increased without increasing the rated power of said wind generator.

13. The wind turbine system, as recited in claim 5, wherein said wind-catching unit further comprises a catcher head mounted around said catcher body for increasing the area of said wind-catching unit in such manner the output power of said wind generator will be increased without increasing the rated power of said wind generator.

14. The wind turbine system, as recited in claim 11, wherein said wind-catching unit further comprises a catcher head mounted around said catcher body for increasing the area of said wind-catching unit in such manner the output power of said wind generator will be increased without increasing the rated power of said wind generator.

15. A wind-catching unit for a wind turbine generator having a generator body mounted onto a upright shaft, and a plurality of turbine blades radially expended from said generator body, wherein said plurality of turbine blades are driven to rotate with respect to said generator body to generate electricity, comprising:
a catcher body mounted onto said upright shaft for providing wind power to said wind turbine generator, wherein said catcher body has a plurality of wind suction channels completely covering four sides and arranged with a side by side manner, wherein each of said wind suction channels has a wind inlet for sucking wind from outside, a wind outlet towards said turbine blades of said wind turbine, and a gradually reduced cavity communicating said wind inlet and wind outlet so as to generate a turbulent pressure between said wind inlet and wind outlet in such a manner that when wind from a direction is caught by respective wind suction channel, said caught wind will be compressed through said gradually reduced cavity so as to effectively blow out from said wind outlet to rotate said generator body with respect to said shaft to generate electricity.

16. The wind-catching unit, as recited in claim 15, wherein each of said wind suction channels is horn shaped with an eccentric angle so as to enable each of said wind outlets is longitudinally provided adjacent to said wind generator blades, and said wind inlet is outwardly and radially extended from said wind outlet with an eccentric angle.

17. The wind-catching unit, as recited in claim 16, wherein each of said wind outlets is positioned orientated towards a circumferential edge of said turbine blade wherein when wind is blow out through said gradually reduced wind suction channel, a compressed wind pressure will impact onto said circumferential edges of said generator blade instead of a central portion of said generator body for ensuring said wind turbine generator effectively driven to rotate.

18. The wind turbine system, as recited in claim 17, wherein said wind-catching unit further comprises a catcher head mounted around said catcher body for increasing the area of said wind-catching unit in such manner the output power of said wind generator will be increased without increasing the rated power of said wind generator.

19. A wind turbine generator assembly, comprising a plurality of wind turbine systems, each of which comprises:
an upright shaft;
a wind turbine generator having a generator body mounted onto said upright shaft, and a plurality of turbine blades radially expended from said generator body, wherein said plurality of turbine blades are driven to rotate with respect to said generator body to generate electricity;
a wind-catching unit mounted onto said upright shaft for circularly sheltering said wind turbine, wherein said wind-catching unit comprises a plurality of wind suction channels covering four sides and arranged with a side by side manner, wherein each of said wind suction channels has a wind inlet for sucking wind from outside, a wind outlet towards said turbine blades of said wind turbine, and a gradually reduced cavity communicating said wind inlet and wind outlet so as to generate a turbulent pressure between said wind inlet and wind outlet in such a manner that when wind from a direction is caught by respective wind suction channel, said caught wind will be compressed through said gradually reduced cavity so as to effectively blow out from said wind outlet to rotate said generator body with respect to said shaft to generate electricity.

20. The wind turbine generator assembly, as recited in claim 19, wherein said plurality of wind turbine system are combined in a horizontal group manner.

21. The wind turbine generator assembly, as recited in claim 19, wherein said plurality of wind turbine system are combined in a vertical group manner.

22. The wind turbine generator assembly, as recited in claim 19, wherein each of said wind turbine system comprises a bird-preventing helmet for protecting birds from being sucked into said wind outlet of said wind-catching unit.

23. The wind turbine generator assembly, as recited in claim 20, wherein each of said wind turbine system comprises a bird-preventing helmet for protecting birds from being sucked into said wind outlet of said wind-catching unit.

24. The wind turbine generator assembly, as recited in claim 21, wherein each of said wind turbine system comprises a bird-preventing helmet for protecting birds from being sucked into said wind outlet of said wind-catching unit.
